(19) United States
(12) Patent Application Publication
(10) Pub. No.: US 2013/0008210 A1
(43) Pub. Date: Jan. 10, 2013

(54) METHOD FOR MANUFACTURING A BIREFRINGENT MICROSTRUCTURED OPTICAL FIBER

(76) Inventors: Yuri Chamorovskiy, Moscow reg., Fryazino (RU); Igor Vorob' Ev, Moscow reg., Fryazino (RU); Victor Voloshin, Moscow reg., Fryazino (RU)

(21) Appl. No.: 13/636,621

(22) PCT Filed: Mar. 22, 2011
(86) PCT No.: PCT/IB2011/051191

§ 371 Date: Sep. 21, 2012

(30) Foreign Application Priority Data
Mar. 24, 2010 (RU) 2010111026

(51) Int. Cl. C03B 37/027; C03B 37/012

(52) U.S. Cl. 65/402; 65/412

(57) ABSTRACT

Method for manufacturing optical fibers, comprising cutting mirror-symmetrical grooves (2, 3) on a preform rod (1) which is inserted into a tube (4) of optical material; fusing the perform rod and the tube in a nonworking area; pulling the fused perform rod and tube into a perform which has longitudinal channels defined by the grooves (2, 3) and the tube (4); cutting the perform (5) into segments; etching the longitudinal channels; sealing segment end(s), assembling segments with a capillary tube and tubular process holder; joining the segment and capillary tube on a side opposite to the tubular process holder; drawing the perform segment into an optical fiber, and applying a protective strengthening coating on the drawn optical fiber. As a result, an optical fiber is produced, which has birefringent properties influenced by dimensions of the mirror-symmetrical grooves and the etching step.

### FIELD OF THE INVENTION

The present invention relates generally to the field of fiber optics and particularly to a method for manufacturing a birefringent microstructured optical fibers. To provide some illustrative but non-restrictive examples, such birefringent microstructured optical fibers may be used in sensors for physical quantities, such as electric current, as well as in equipment for processing signals in the optical domain.

### BACKGROUND OF THE INVENTION

Methods for manufacture of microstructured optical fibers include preform ‘manufacture step and fiber drawing step. Manufacture of preforms involves’ well-known methods including drilling, grinding, polishing, etching and expanding longitudinal channels in preforms, assembly and pulling of quartz preforms made of a set of tubes and rods of various cross-sectional shapes; forming of preform structure by forcing through a mould or die (the method is suitable for light-alloy low melting point materials, for instance, polymers) etc.

Reference document [1] discloses a technique for making optical fiber gratings having an internal gap cladding for reduced short wavelength cladding mode loss. The core of the fiber is isolated from the reflection cladding by a layer of longitudinal air channels. The air channels have links or struts the thickness of which is below the transmitted wavelength and which are arranged circumferentially relative to the core center at a distance of 2 to 10 times the biggest transmitted wavelengths. The core is somewhat suspended in air or another gas in longitudinal channels. Such fibers can be regarded as micro-structured optical fibers with a suspended core, abbreviated “MOFSC” in the following.

Reference document [2] discloses another known manufacturing technique and fiber, known as PANDA. Linear birefringence in the PANDA optical fiber is characterized by a beating length of polarization modes, the beating length being inversely proportional to birefringence and directly proportional to measurement wavelength. With a wavelength of 1550 nm in a PANDA fiber, the beating length reaches a value of about 2 mm while in the claimed MOFSC structure it amounts to about 100 μm.

MOFSC structures make it possible to achieve even higher linear birefringence values with relatively low optical losses and, for instance, use sensitive outline coils in current sensors with a small diameter and a large number of turns, which result in a high sensitivity to magnetic field (which is proportional to the current being measured). This is particularly true for a spiral structure of a fiber's linear birefringence axis, that is, these axes periodically rotate along the fibre.

Reference document [3] discloses a process and device for producing a holey optical fiber. The process comprises several stages: a stage of production of a preform having an axis of symmetry and comprising an optical core and two side channels whose axis is parallel to the axis of symmetry of the preform; an over jacketing of the above perform with an additional supporting tube; and a drawing stage at a temperature making possible the softening of the drawn part of the preform to obtain a hollow optical fiber. The process further comprises, after the preceding stage of production of the preform: a stage of attachment in a tight manner, to the upper end of the preform, of a hollow chamber whose cavity communicates with the recesses (holes) of the preform. The cavity also communicates with a pneumatic regulation device. The drawing stage comprises a pneumatic regulation of the gas contained in the cavity and in the recesses (holes) with the help of the pneumatic regulation device.

This process makes it possible to obtain hole-assisted fiber due to formation of grooves in the reflection cladding. A disadvantage of this method is the impossibility to obtain an optical fiber with a high birefringence because of incomplete suspension of the core. Another disadvantage is that the method is poorly or not at all suited to production of an appreciable difference in the indices of refraction between the core and cladding.

Reference document [4] discloses a process for the fabrication of microstructured fibres. In this process, a preform for a microstructured fibre or a part for a preform for a microstructured fibre is made. The preform or part has a length in the longitudinal direction and a cross section perpendicular thereto, and includes a rod arranged at the centre of the preform or part, with one or more tubes being concentric to the rod. The rod is sleeved inside a first of the concentric tubes, and the rod and/or at least one of the concentric tubes has identical grooves and/or slits in each rod or tube, the grooves or slits extending in the longitudinal direction, with an even number of innermost longitudinally extending grooves and/or slits with respect to a centre of the preform or part.

The method according to reference document [4] enables production of a micro-structured optical fiber, in which the core is isolated from the reflection cladding by a layer or layers of symmetrical air channels parallel to the axis of the optical fiber.

The micro-structured fiber is obtained due to making grooves parallel to structure axis in starting rods and/or tubes. Then the rods and tubes are assembled, axially and symmetrically aligned to obtain a starting preform which has air channels on layers the number of which depends on the number of tubes used that have cut grooves. The process necessarily results in axial symmetry of the starting preform structure and of the resulting optical fiber. Thus the method according to reference document [4] is suitable for making a MOFSC with a circular-shaped core. A disadvantage is that this technique does not make it possible to obtain fibers with cores and cladding of various geometries, in particular. As a result, the technique of reference document [4], is not suitable for the production of birefringent fibers.

### SUMMARY OF THE INVENTION

It is an object of the invention to alleviate one or more of the problems identified above. In other words, it is an object of the present invention to provide improvements relating to production of micro-structured birefringent optical fibers. The object of the invention is achieved by a method as defined in the attached independent claims. The dependent claims as well as the present patent specification and drawings provide specific embodiments which provide additional features and/or solve additional problems.

An aspect of the invention is a method for manufacturing an optical fiber. The method comprises the following process steps, which are labelled to facilitate discussion:
a) making two or more pairs of longitudinal grooves on a preform rod, over its entire length, wherein the two or more pairs of grooves are mirror-symmetrical relative to at least one plane passing through a longitudinal rotation axis of the preform rod and wherein within each pair of grooves the shape and size of the grooves are similar;
b) inserting the preform rod into a tube of optical material, the tube having an inner surface with a diameter not smaller than an external diameter of the preform rod;
c) fusing the preform rod and the tube in a nonworking area;
d) pulling the fused preform rod and tube into a preform, the preform having longitudinal channels resulting from the mirror-symmetrical grooves and the inner surface of the tube;
e) cutting the preform into at least one preform segment;
   performing the following steps for at least one preform segment:
f) etching the longitudinal channels of the preform segment to form etched channels;
g) sealing both ends of the preform segment;
h) making an assembly of the preform segment and a capillary tube carrying a tubular process holder;
i) fusing the preform segment and the capillary tube on a side opposite to the tubular process holder;
j) drawing the assembly of the preform segment and the capillary tube into an optical fiber, and
k) applying a protective strengthening coating on the drawn optical fiber.

In step a) the process begins by making two or more pairs of longitudinal grooves on a starting preform rod, which is typically cylindrical and formed of optical material suitable for fiber optic applications. For instance, the starting preform rod can be made of high-purity fused quartz (silica). The feature ensures obtaining a preform as free of contamination impurities as possible, whereby the preform, and the eventual completed fiber, possesses desired properties and contains dopants that ensure a desired refraction index. The arrangement of the grooves constitutes one departure from the prior art, in which the channels of the MOFSC have full rotational symmetry around the longitudinal rotation axis of the fiber. For instance, if the number of channels is four, the prior art teaches a structure with full 2π/4 (90°) rotational symmetry. In the prior art microstructured fibers a rotation of 2π/4 (90°) results in an identical arrangement of the channels. Such a microstructure does not support manufacture of birefringent optical fibers. To this end, the longitudinal grooves are made such that the entire set of grooves is mirror-symmetrical relative to at least one plane passing through the longitudinal rotation axis of the starting preform rod. Within each pair of grooves the shape and size of the grooves are similar. This means that the set of grooves in the inventive process have mirror symmetry relative to at least one plane passing through the longitudinal rotation axis, but the set of grooves have only π (180°) rotational symmetry. It is the mirror symmetry and lack of full rotational symmetry that makes it possible to manufacture optical fibers with birefringent optical properties. The grooves can be cut by a precision grinder, for example. Due consideration should be given to the impact of deformation strains in subsequent manufacturing steps. After cutting the grooves, the starting preform rod is typically cleaned, for example by washing and drying. The cleaning step ensures that the rod is free from impurities that could cause losses in the completed optical fiber.

The next process step b) comprises inserting the preform rod into a tube of optical material, such as quartz. The inner surface of the tube has a diameter not smaller than the external diameter of the preform rod, whereby the preform rod can be inserted into the tube with minimal slack.

Step c) comprises fusing the preform rod and the tube in a nonworking area. In the present context, a nonworking area means an area to be discarded later. Such fusing can be accomplished by using a localized heating device, such as a gas burner, for example. The feature ensures that the tube is secured on the preform rod and a non-detachable joint is obtained which is sealed at one end.

Step d) comprises pulling the fused preform rod and the tube of optical material into a preform. This processing step ensures successful pulling and simultaneous jacket covering by a tube overlap, whereby a desired diameter for the preform is obtained. The preform exhibits an internal structure formed by longitudinal channels which result from the mirror-symmetrical grooves and the inner surface of the tube. The cross-sectional dimensions of the preform are much reduced compared with the dimensions of the preform rod and tube before pulling, and acute contours, such as sharp angles, are significantly rounded.

Step e) comprises cutting the preform into one or more segments, which are called preform segments in the following. In the interest of clarity, the following description is written for a single segment but all preform segments can be processed similarly. The cutting step results in preform segments of a length that corresponds to the length of the working part of the preform.

Step f) comprises etching the longitudinal channels of the preform segment, whereby etched channels are formed within the preform segment. The etching process may be accomplished by pumping HF acid under pressure through the channels, for example. The dimensions of the microstructure of the preform, and of the eventual completed fiber, are influenced by the initial size and shape of the grooves, the inner diameter of the tube, the dimension reduction from the pulling process, as well as the etching process. The dimensions of the resulting microstructure, and the optical properties of the material and dopants, determine the birefringent properties, as well as some other properties, such as lasing properties for rear earth doping, of the eventual fiber. The etching process also thins the link struts to a thickness that is below the wavelength of transmitted light in the completed fiber. As a result, after the etching the link struts are too thin to leak light away from the core of the resulting fiber. After the etching process, the internal and external surfaces of the preform segment may be cleaned, for example by washing and drying, so as to remove impurities that might cause losses in the resulting optical fiber.

Step g) comprises sealing at least one end and preferably both ends of the preform segment. Similarly to step c), the sealing can be accomplished by a localized heating device, such as a gas burner. The sealing step attaches the preform segment to the surrounding tube and prevents ingress of impurities, foreign fumes and gases into the internal channels.

Step h) comprises assembling the preform segment with a capillary tube carrying a tubular process holder. In step i) the preform segment and the capillary tube are joined on a side opposite to the tubular process holder. A non-detachable joint between the preform segment and the capillary tube can be accomplished by fusing, for example. A gap may be left on the opposite end between the internal surface of the capillary quartz tube and the preform segment. A benefit of this process step is that the preform is conveniently secured for the following fiber drawing step. Furthermore, the diameter and mass of the preform are increased which is why this step enables manufacture of optical fibers of virtually any desired diameter.

Step j) comprises drawing the preform segment into an optical fiber, while step k) comprises applying a protective strengthening coating on the drawn optical fiber. These steps may be similar to the corresponding steps known from the prior art.

A departure from the prior art is seen in the microstructure of the fiber core, which is determined by the arrangement of the grooves, their shape and dimensions, the inner diameter of the tube, and the etching process. As a result, an optical fiber is produced with desired birefringent properties.

Birefringence of the resulting fiber core is given by:

$$K \cdot ( \frac{a - b}{a + b} ) \cdot Δ {n}^{2}$$

Herein K is a proportionality factor, a and b are the major and minor axes of the ellipse inscribed by the grooves, the ratio of (a−b)/(a+b) is the ellipticity of the ellipse inscribed by the grooves, and Δn is the difference between the refractive indices of the core and cladding. In order to achieve birefringence, the major and minor axes of the ellipse inscribed by the grooves must differ in magnitude. For practical applications, the ellipticity should be 0.05 or higher.

The inventive manufacturing process is applicable to a wide range of different geometries of the optical fiber core. The process is capable of manufacturing optical fibers with a linear birefringence of 1*10⁻² or higher. Tests have shown that the process is capable of manufacturing optical fibers with retaining optical losses at about 2 db/km at a wavelength of 1550 nm. The losses are mainly dependent on the quality of the quartz, the number and size of transverse micro-cracks. At this point it is worth mentioning that the channel drilling methods used in the prior art may result in excessive amounts of micro-cracks and contamination within the channels. Furthermore, the drilling methods used in the prior art tend to require more expensive high-precision drilling equipment compared to the inventive process in which the channels are formed by cutting (e.g. by grinding) open grooves, which are later closed by inserting the preform into the optical tube.

As stated in the introductory portion of this document, at a wavelength of 1550 nm in a PANDA fiber, the beating length reaches a value of about 2 mm. In contrast, the manufacturing process of the present invention is capable of manufacturing a MOFSC structure in which the beating length is approximately 100 μm, which is a 20:1 improvement.

In the following description of specific embodiments, the terms “first embodiment” through “third embodiment” refer to various geometries and/or manufacturing techniques for the fiber core. “Optional features” refer to features which provide additional benefits and/or solve residual problems, and such optional features can be combined with each other and/or any of the numbered embodiments.

According to one optional feature the preform segment may be rotated during the step of drawing the preform segment into the optical fiber, so as to obtain a spiral axis structure. Such a spiral axis structure provides the possibility of elliptical polarization modes propagating along the fiber, which is particularly useful in current-sensing applications, for example.

According to another optional feature, the preform may be sealed at both ends and, optionally, filled with pressurized gas before sealing. This technique protects the fiber core from excessive compression and fractures, reduces micro cracks and thus helps improve the microstructure of the resulting fiber.

### BRIEF DESCRIPTION OF THE DRAWINGS

The inventive method will be easier to understand in the context of specific non-restrictive embodiments, as described in more detail in the following, whereby a reference is made to the attached drawings in which like reference signs or numerals denote like items.

FIG. 1 shows an exemplary arrangement and shape grooves on the core preform in an embodiment employing two pairs of grooves;

FIG. 2 illustrates cross-sectional assembly of a preform rod with a quartz tube;

FIG. 3 shows a diagram for fusion of the preform rod with the quartz tube;

FIG. 4 shows a diagram for pulling the preform rod and the quartz tube into the preform;

FIG. 5 shows a diagram for etching channels in the preform;

FIG. 6 shows a diagram for sealing the preform ends;

FIG. 7 shows a diagram for fusion of the preform and a capillary tube;

FIG. 8 shows a cross section of a MOFSC;

FIG. 9 illustrates a second embodiment of the inventive manufacturing process, and particularly the arrangement and shapes and dimensions of the grooves cut on the core preform;

FIG. 10 shows a micrograph of the cross section of the MOFSC core with 6 channels obtained by the second embodiment;

FIG. 11 shows a micrograph of the cross section of MOFSC with 6 channels obtained by the second embodiment; and

FIGS. 12-16B illustrate a third embodiment of the inventive manufacturing process.

### DETAILED DESCRIPTION OF SPECIFIC EMBODIMENTS

### First Embodiment

Reference numerals are assigned as follows in FIGS. 1 through 8: 1—preform rod, 2—first pair of grooves I-I, 3—second pair of grooves II-II, 4—glass (quartz) tube, 5—preform, 6—fusion point, 7—pulled preform, 8—starting channel profile, 9—etched channel profile, 10—channel link struts, 11—preform core area, 12—sealed end of the preform, 13—capillary tube, 14—tubular holder, 15—fusion point of a preform segment 7 and capillary tube 13, 16—gap, 17—protective strengthening coating, 18—MOFSC core area, 19—fiber process matrix area.

Letter symbols assigned as follows in FIGS. 1 through 8: A—major axis of ellipse of the preform rod in the cross section, B—minor axis of ellipse of the preform rod in the cross section, d—preform rod diameter, D—inner diameter of quartz tube, D_{H}—outer diameter of quartz tube 4, Dp—pulled preform diameter, Dk—outer diameter of quartz capillary tube, dk—inner diameter of quartz capillary tube, L—pre-preform segment length; S—non-etched channel link strut thickness, s—etched channel link strut thickness; GB—gas burner.

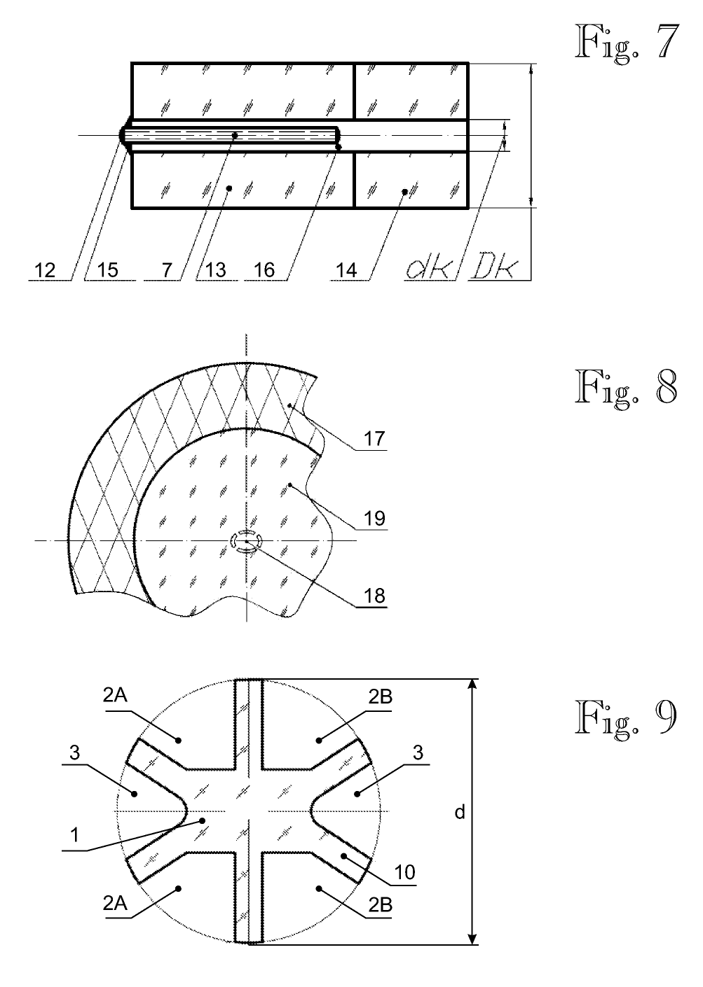

Referring to FIG. 1, an illustrative embodiment the inventive method is implemented as follows. The method begins by making a cylindrical starting preform rod 1 with a diameter of d. Next, the starting preform rod 1 is cleaned from impurities to the maximum extent. Dopants may be added, if necessary, to get desirable properties, such as a targeted refraction index factor. For some applications the starting preform rod 1 can be made of pure quartz. For other applications, the quartz may be doped to give it properties desirable in those applications. For instance, the quartz may be doped with rare earth elements to obtain laser properties. Or, the quartz may be doped with different dopants to increase the photo sensitivity of its refractive index (to record write Bragg gratings). Longitudinal grooves are made on the external surface of the preform rod by mechanical machining, such as by longitudinal grinding, or by some chemical processing, laser cutting or by any combination of such processing techniques. This makes it possible to avoid labour-intensive and precision processes such as longitudinal drilling of channels in the preform rod and have the channel surface free of any transverse micro cracks that increase waveguide losses. To obtain a MOFSC with a nearly elliptical suspended core in the cross section, an example of which will be shown in FIG. 8, an even number of grooves are processed in pairs, such that two or more pairs of grooves are processed mirror-symmetrically relative to at least one plane passing through a longitudinal rotation axis of the starting preform rod 1. In the embodiment shown in FIG. 1, reference numerals 2 and 3 respectively denote a first pair of grooves I-I and a second pair of grooves II-II. Within each pair of the grooves 2, 3 the shape and size of the grooves are identical, or as close to identical as possible, given the manufacturing tolerances. The number of the groove pairs, their dimensions (depth, width, cross-sectional shape) and arrangement depend on a desired MOFSC structure, while all due consideration is given to impact of strains deformation in the subsequent manufacturing steps. The example shown in FIG. 1, has four grooves, which can be arranged orthogonally. The preform rod 1 with processed grooves 2 and 3 are washed and dried to remove impurities that may causes losses in the eventual optical fiber.

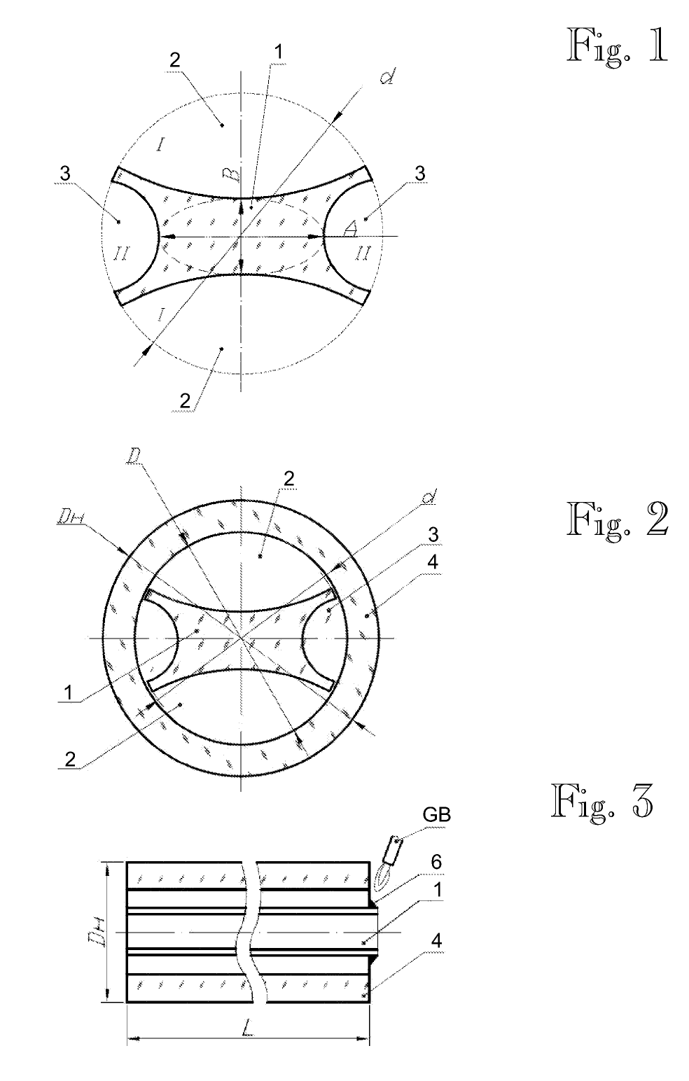

FIG. 2 illustrates a process of making channels in the preform. As shown in FIG. 2, the preform rod 1 with processed grooves 2 and 3 is assembled with a tube 4, whose optical and mechanical properties are similar or close to that of the preform rod 1. For instance, the tube 4 may be glass, quartz or similar material. The inner diameter D of the quartz tube 4 is to match or slightly exceed the outer diameter d of the preform rod 1, such that the preform rod 1 can be inserted into the tube 4.

FIG. 3 illustrates fusion of the preform rod 1 with the glass or quartz tube 4. By using a point gas burner GB the preform rod 1 and quartz tube 4 are fused in a nonworking area 8 to produce a fixed joint, which is convenient for further work. This process increases the diameter d of the preform rod 1 with inner channels to reach the size Du, which is suitable for subsequent pulling. The assembly thus formed is denoted by reference numeral 5.

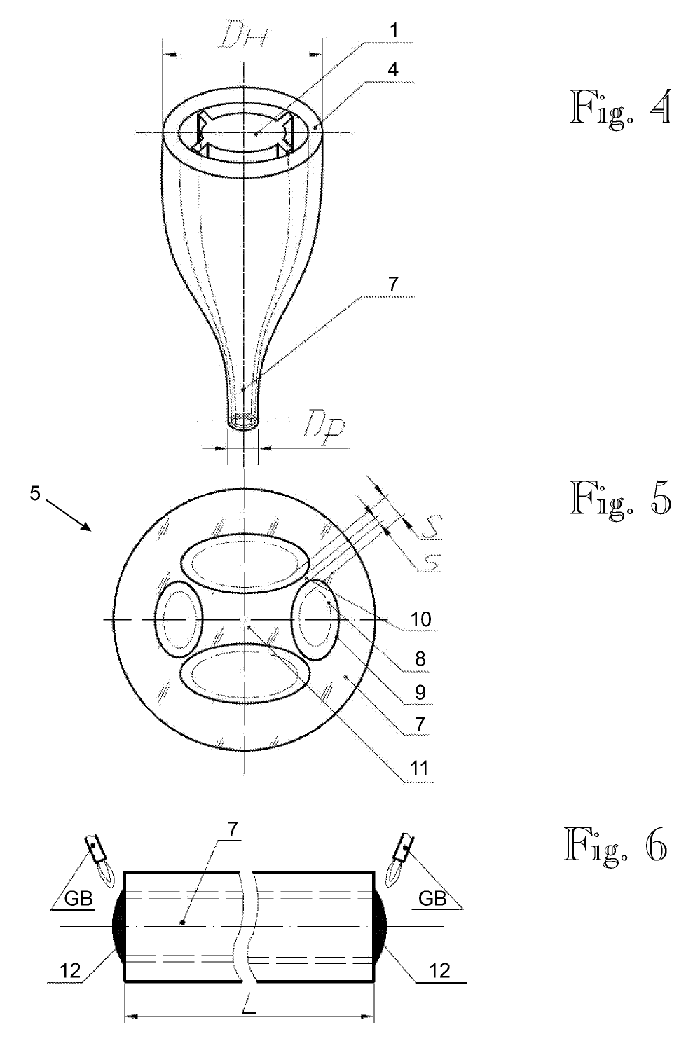

FIG. 4 illustrates a processing step in which the preform rod 1 and quartz tube 4 are pulled into a preform, denoted by reference numeral 7. At this step the pulling follows the principle of geometrical similarity where the shape of the central part is unchanged. The result is a pulled preform 7 of a desired diameter Dp. Next, the preform 7 is cut into segments of length L corresponding to the length of the working part of the preform subsequently used for fiber drawing. The length L of the segments depends on the capability of the equipment being used.

FIG. 5 shows cross-sectional view of the preform 7, wherein the dash-dotted lines 8 denote initial shapes for channels formed by the grooves 2, 3, and the internal wall of the tube 4. As shown in FIG. 5, the shape of the channels 8 has been rounded in the pulling process discussed in connection with FIG. 4.

FIG. 5 further illustrates a processing step in which the channels 8 in the core preform are etched with HF acid, for example. As a result of the etching process the dimensions of the channels increase to the shape denoted by reference numeral 9. At the same time, the thickness of the links struts 10 decreases from S to s. The external and internal surfaces of the core preform are cleaned and dried. For example, a flow of a dry noble gas, such as argon, can be used to remove the HF acid and any contaminants.

FIG. 6 illustrates a processing step in which both ends of the preform segment 7 are sealed. Reference numerals 12 denote the points of sealing. Then, as shown in FIG. 7, the preform 7 is assembled with a capillary tube 13. As a result, the material volume of the preform increases. An auxiliary tubular process holder 14 is sealed to the capillary tube 13 to make it more convenient to secure the preform at the pulling step. The preform is obtained by fusing the preform segment 7 and capillary quartz tube 13 on the side opposite to the tubular process holder 14 at the point 15. At the end closer to the process holder 14, a gap 16 is left between the preform segment 7 and the internal surface of the capillary quartz tube 13. The sealing step has the effect that the gas trapped inside protects the fiber core from compression.

Next, as shown in FIG. 8, the preform is drawn into an optical fiber having a fiber core area 18 and a MOFSC process matrix area 19. A protective strengthening coating 17 is applied to the optical fiber. The process matrix area 19 is used to add mechanical strength to the MOFSC and to simplify its handling. Drawing a preform with sealed ends of the preform segments 7 makes the channels uniformly expanded and the partitions walls (struts) uniformly thinned. A MOFSC with a high birefringence and low attenuation is thus obtained. In the cross section shown in FIG. 8, the fiber core has a regular star-shaped structure with the dimensions determined by those of the inscribed ellipse, and the beams are link struts between the channels. The thickness of the link struts may be about 100 nm or less.

In a variant of the inventive method the process step of drawing the preform is into the optical fiber comprises applying a protective strengthening coating together with a simultaneous rotation of the optic fiber preform. The effect of the simultaneous rotation of the optic fiber preform during the drawing is a MOFSC with a spiral structure of the birefringent axes. Such birefringent axes with a well-defined spiral structure may be used in sensors of physical quantities, such as electrical current sensors or magnetic field sensors.

In the interest of clarity, real-world dimensions have been omitted in the above description of the operating principle of the invention. The following description of specific use cases is provided by exemplary dimensions, which are to be construed as dimensioning guidelines rather than absolute restrictions of the invention.

### Second Embodiment

FIG. 9 illustrates an embodiment of a manufacturing method for a MOFSC with a high linear birefringence, such as approximately 1*10⁻². A starting cylinder-shaped rod 1 with diameter d=19 mm and length L=150-200 mm is made. Three pairs of grooves 2A, 2B and 3 are processed mirror-symmetrically relative to the plane passing through the longitudinal rotation axis of the preform, 5 mm deep semi-circular grooves 3 with a 2 mm radius at the top along one axis, and two pairs of trapezoidal grooves 2A, 2B with an inner base (closer to center) size of 3.5 mm and outer “base” being a partial circle with a length 8.75 mm, and as much as 6.5 mm in depth along the other axes. In this example an irregular groove shape will ensure that the core has the pre-designed size of 9 mm×6 mm and all the link struts 10 have the same thickness, such as 2 mm. The grooves 2A, 2B and 3 on the rod 1 are made, for instance, by grinding on a profile surface grinder with a longitudinal disc movement (relative to the rod) equipped with a device to enable security and periodic rotation of the preform rod 1. The preform rod 1 with the processed grooves is washed and dried. Similarly to the first embodiment (FIGS. 3-4), the resultant rod structure is inserted into the quartz tube 4 with an inner diameter D=20 mm and outer diameter D_{H}=25 mm, fused in the nonworking area (point 6 in FIG. 3) and pulled into the preform structure 7 with a diameter Dp=1.1 mm. Pulling is preformed in a drawing tower using a high temperature electrically heated furnace, with the diameter of the drawn preform structure carefully controlled. The preform 7 is cut into segments 150-200 mm in length corresponding to the length of the working part of the preform. The preform structure 7 is internally etched (cf. FIG. 5) to reach the targeted dimensions in the core area with the relevant sizes: A=400 μm and B=270 μm and minimum sizes of the links struts 10-40 μm in width. The external and internal surfaces of the core preform are washed and dried in a dry argon flow to remove the acid and any contaminants. An auxiliary tubular holder 14 is sealed to the capillary tube 13 (cf. FIG. 7). The resultant structure 7 with a diameter Dp=1.1 mm is sealed from both ends and inserted into the capillary quartz tube 13 carrying the holder 14, with the pre-designed ratio of Dk=14.5 mm and inner diameter equal to at least dk=1.11 mm. A minimum 0.01 mm gap (clearance) 16 is left on opposite end between the internal surface of the capillary quartz tube 13 and the preform segment 7. The structure thus obtained is drawn into an optical fiber with the pre-designed ratio of the fiber diameter 80 μm and a core size of approximately 2.5 μm×1.6 μm, and a link strut width of about 100 nm, accordingly. The fiber is drawn into an optical fiber at a drawing tower, with simultaneous application of a protective strengthening coating 17, which may be an acrylate coating for instance. The diameter of the drawn fiber is maintained with a high accuracy, such as about 1 μm, using an instrumentation system. For example, such an instrumentation system may perform accurate measurements of the diameter of the fiber and provide a feedback signal to the control system that controls the fiber-drawing process.

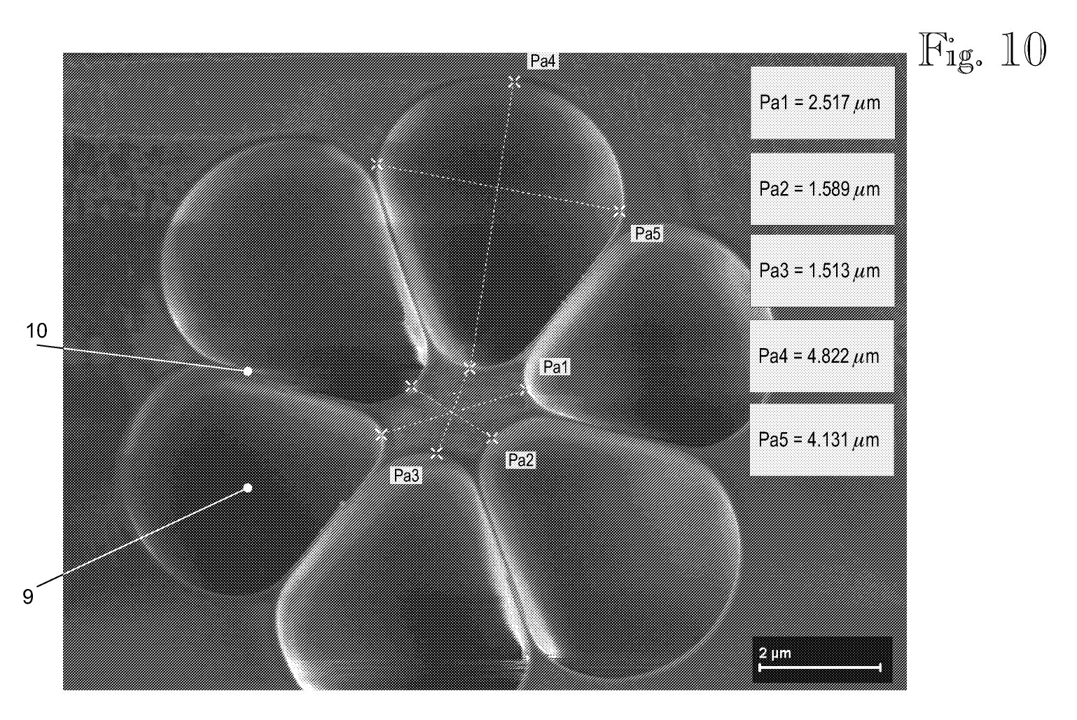

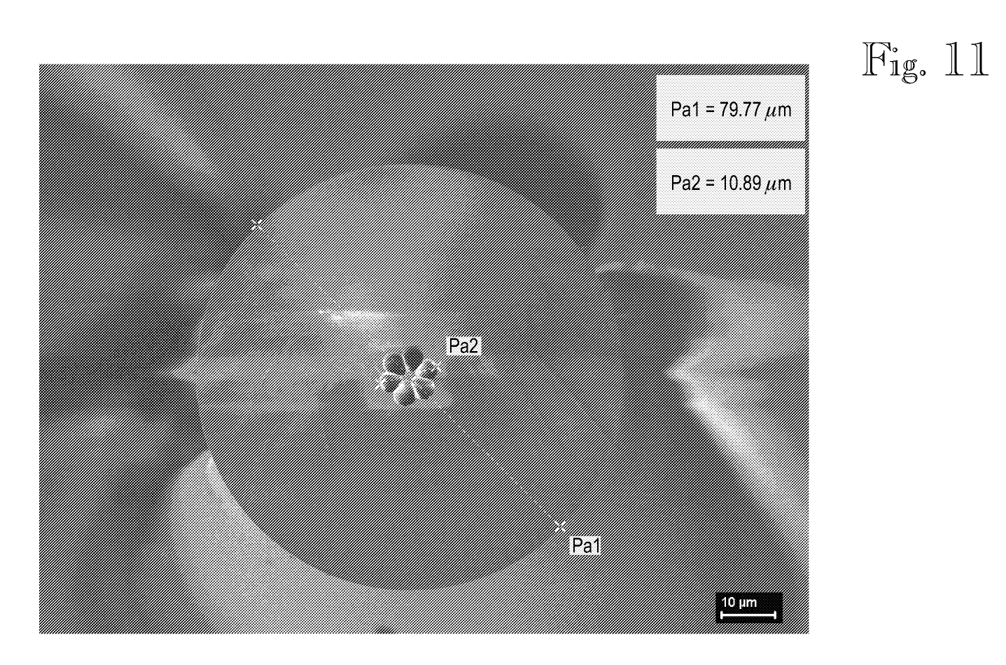

Reference document [5] describes a MOFSC fiber manufactured by the method of the second embodiment, but the actual manufacturing method has not been disclosed. The MOFSC fiber has a birefringence value of 1*10⁻², which is proved by experimental data. FIG. 10 shows a core micrograph proving that a MOFSC with 6 channels has been produced by the method described herein. FIG. 11 shows a micrograph of the cross section of the MOFSC with 6 channels produced by the inventive method. The dimensions shown in FIGS. 10 and 11 are actual measurements obtained from the display of an electron microscope, and such measurements are not given as restrictions in a strict sense. Two important benefits of the invention are apparent from the micrographs of FIGS. 10 and 11. Firstly, the resulting MOFSC clearly has a core with different major and minor axis dimensions. This feature brings about the desired predetermined birefringence. Secondly, the thickness of the struts 10 that support the core is clearly lower than the wavelength of light, which means that the struts do not leak light from the core of the fiber to its envelope.

### Third Embodiment

The third embodiment relates to a method for manufacturing a birefringent microstructured fiber with a moderate ellipticity of the fiber core and a four-groove cladding structure. For example this method is suitable for manufacturing birefringent microstructured fibers with a fiber core whose minor axis is about 80% of the major axis.

The manufacturing steps of the third embodiment are substantially similar to those of the first embodiment, although the shape of the fiber core differs between the embodiments.

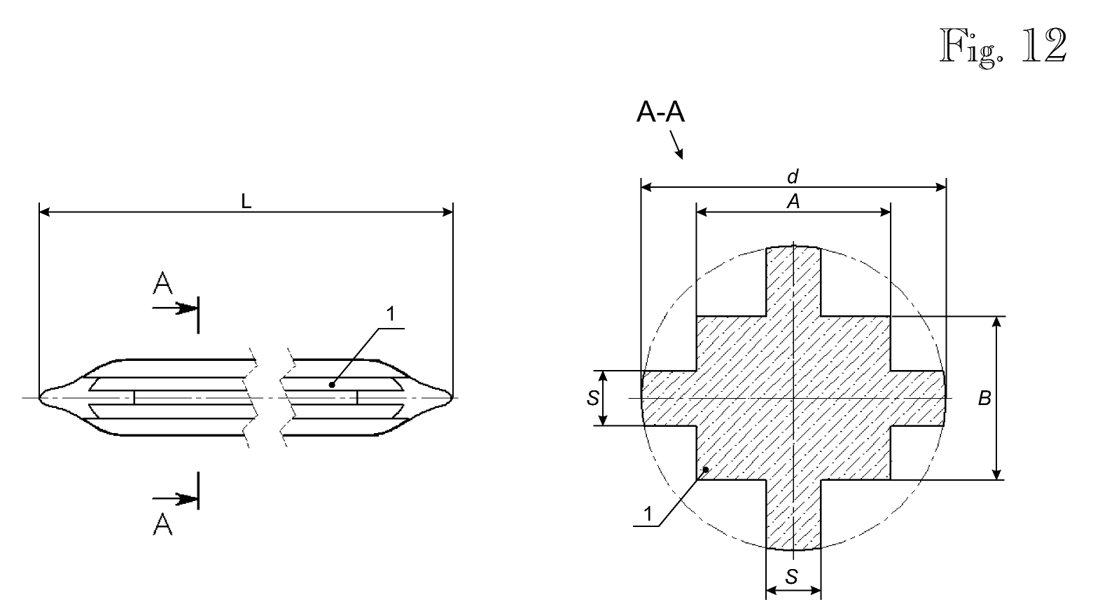

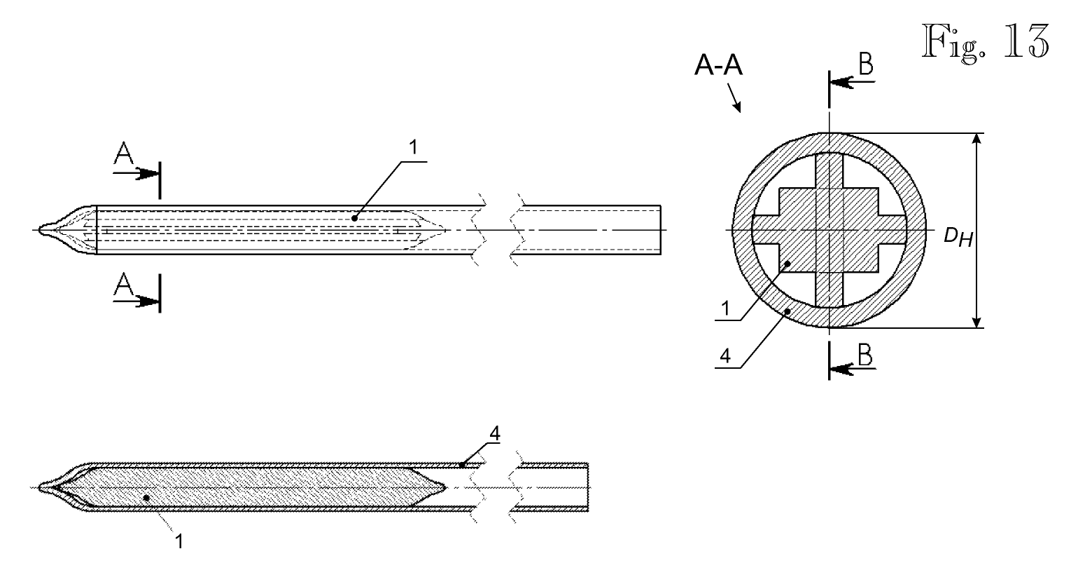

First, as shown in FIG. 12, a preform rod 1 is provided by grooves by grinding and polishing. The relative dimensions of the core portion of the preform rod determine the ellipticity of the resulting optical fiber. In this particular implementation, the following dimensions were used: d=20 mm, A=12.8 mm, B=10.8 mm, S=3.6 mm. Next, the preform rod is cleaned and dried. Then, as shown in FIG. 13, the preform rod is inserted into an appropriately-sized silica tube 4 with a diameter D_{H}=25 mm, and fused at one end.

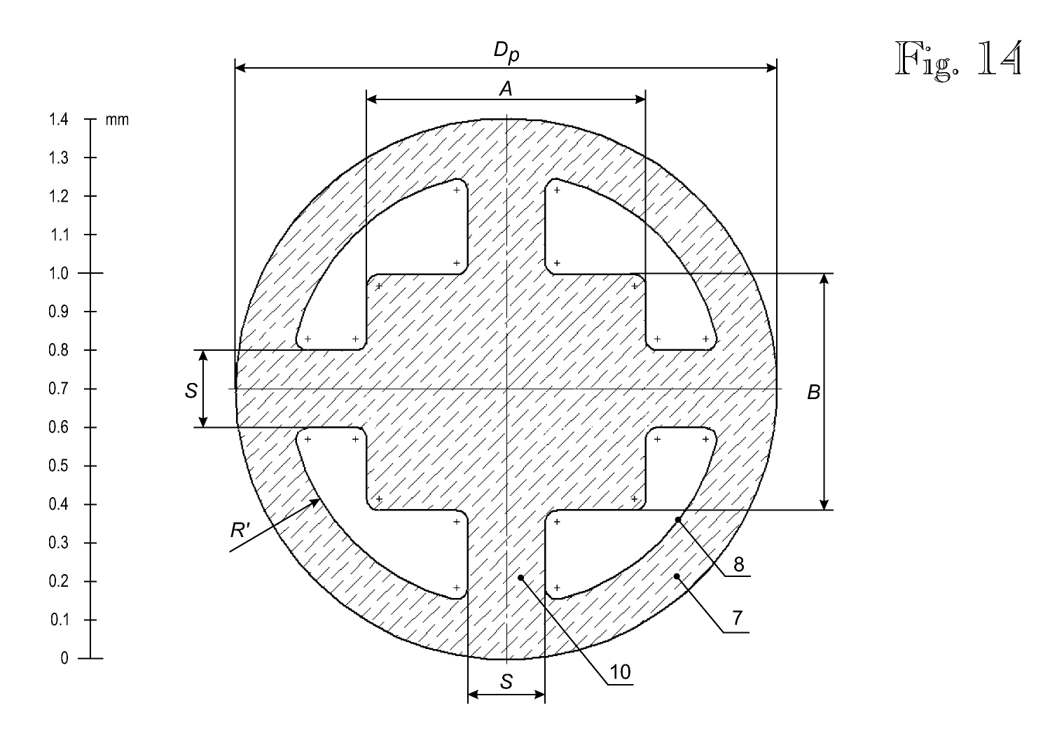

After inserting into the silica tube 4 and fusing, the preform rod 1 is drawn in a tower to convert the preform rod to a preform 7 whose cross-section has greatly reduced outer dimensions compared with the dimensions of the preform rod. FIG. 14 shows a cross-sectional view of the preform as obtained from the drawing tower. In this particular implementation, the dimensions were as follows: Dp=1.40 mm, A′=0.72 mm, B′=0.61 mm, R′=0.56 mm, s=0.2 mm.

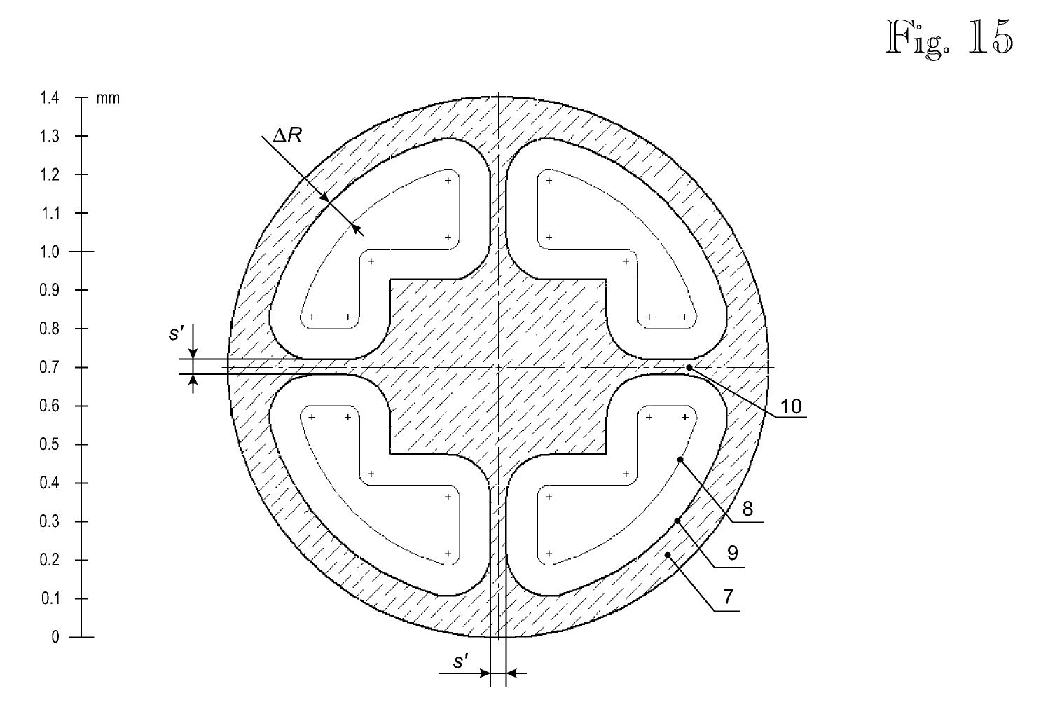

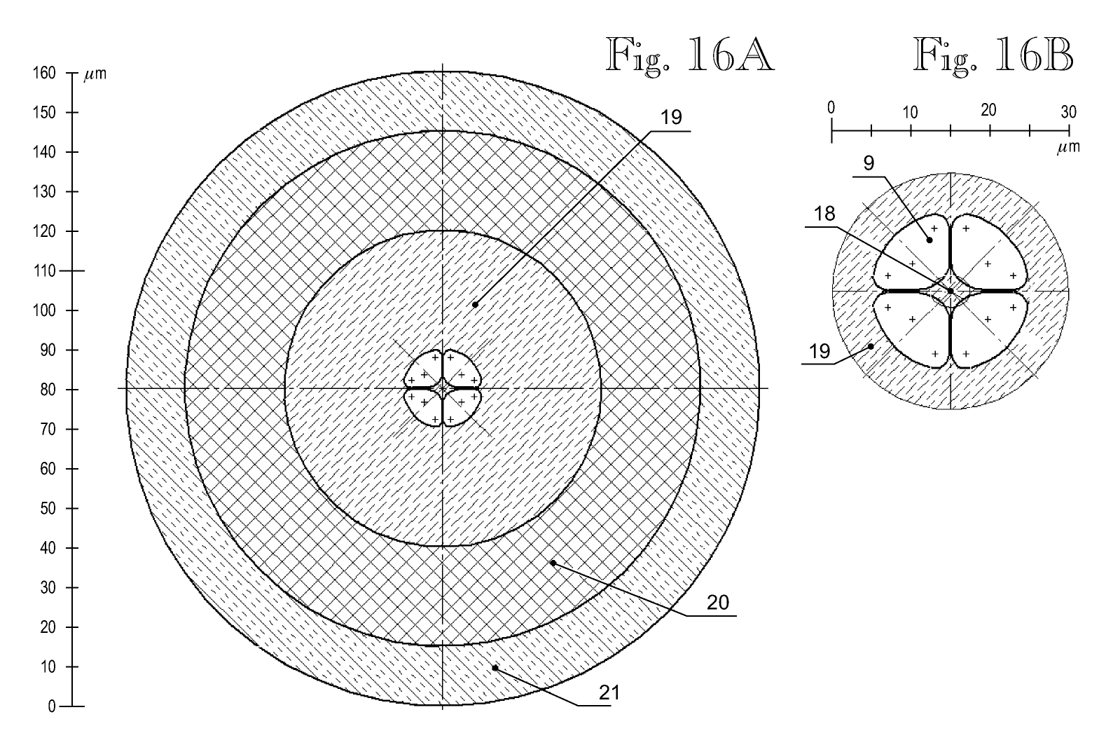

The internal channels 8 are etched with HF acid. The etched channels 9 are cleaned and dried. FIG. 15 shows a cross-sectional view of the fiber core after the etching process. In this example, the etching process opens the channels by an amount ΔR=0.08 mm, and after etching, the strut widths are s′=0.04 mm. Finally, as shown in FIG. 16A, the preform is inserted into an additional thick-walled tube 19-21, and this assembly is drawn into a completed fiber. In the present embodiment, the thick-walled tube comprises a process matrix area 19, surrounded by a soft layer 20, which in turn is surrounded by a hard layer 21. Compared with the two-layered coating shown in FIG. 8, the three-layered coating shown in FIG. 16A provides improved optical properties, such as a lower attenuation within a wide temperature range. FIG. 168 shows a magnified view of the central portion of the fiber (relative magnification of 2:1 compared with FIG. 16A.

Details of the process of the third embodiment can be implemented similarly to the first embodiment. For instance, the preform is cut into segments, and each segment is sealed at its ends. A protective coating is applied during the drawing step, and for a sensing fiber for a current sensor the assembly comprised of the preform and tube may be rotated during the drawing step to obtain a spiral axis structure, and so on. Although the first embodiment was described in connection with a simpler coating arrangement and the third embodiment with a more complex coating, it is self-evident that the coating arrangement is independent of the method in which the fiber core is manufactured.

An advantage of the manufacturing process of the third embodiment is that simpler equipment is required for the groove-cutting process. This is because all grooves cut into the preform rod have only planar (flat) walls, in comparison to the curved walls used in the first embodiment. In spite of the simpler equipment required, the process of the third embodiment provides a simple way to change the ellipticity of the preform rod. In the present context, “ellipticity” refers to the ratio of the major and minor axes of an ellipse enveloped by the preform rod after the groove-cutting. The ellipticity of the preform rod influences the ellipticity of the core of the resulting optical fiber and its optical properties, most notably its birefringence.

As noted, the manufacturing steps are substantially similar between the various embodiments, and the differences between the embodiments examples lie mainly in the central core portion of the preform and of the eventual completed fiber. There are two principal factors that influence these differences. Firstly, the sealed ends of the preform-tube assembly result in increased pressure inside the internal channels, which in turn results in a greater proportion of channel area in the cross-section of the preform. Secondly, the surface tension force during the drawing step causes a certain smoothening of the cross-sectional shape. That is, sharp angles are rounded because of the increased surface tension.

It is a common feature to all of the three embodiments described above in detail that the overall arrangement of grooves cut on the preform rod has mirror symmetry relative to two axes (shown as vertical and horizontal axes in FIGS. 1, 5, 8, (first embodiment), 9 (second embodiment) and 12-16 (third embodiment). Yet the overall arrangement of grooves has only π (180°) rotational symmetry relative to the longitudinal axis of the preform rod. The presence of mirror symmetry and absence of 2π/n rotational symmetry (n being the number of grooves, such as 90° rotational symmetry for 4 grooves) ensures that the desired birefringent properties of the optical fiber can be achieved by appropriate arrangement and dimensions of the grooves. A key point here is that the overall placement, size and shape of the grooves determines the ellipticity of the resulting fiber core, and thus influences its birefringence, while leakage of light from the fiber core is reduced or eliminated by etching of the link struts between the channels (that result from the grooves) to a thickness below the wavelength of transmitted light.

The above description of the specific embodiments and optional features is illustrative rather than restrictive. It is apparent to those skilled in the art that with advancing technology, the invention can be implemented in various forms without departing from the scope of protection defined by the following claims.

### REFERENCES

1. U.S. Pat. No. 6,415,079, 2002. Optical Fiber Gratings Having Internal Gap Cladding for Reduced Short Wavelength Cladding Mode Loss.
2. PM1550G-80. 1550 μm Polarization Maintaining Gyroscope & Sensor Fiber [Electronic recourse]. Website: Nufern—Access mode: http://www.nufern.com/fiber_detail.php/44 free.
3. U.S. Pat. No. 5,167,684, 1992. Process and Device Producing a Hollow Optical Fiber.
4. U.S. Pat. No. 7,155,097, 2006. Fabrication of Microstructured Fibers.
5. Miniature microstructured fiber coil with high magneto-optical sensitivity. Yu. K. Chamorovskiy, N. I. Starostin, M. V. Ryabko, A. I. Sazonov, S. K. Morshnev, V. P. Gubin, I. L. Vorob'ev, S. A. Nikitov. Optics Communications, 282, (2009), 4618-4621

1. A method for manufacturing an optical fiber, the method comprising:
making two or more pairs of longitudinal grooves (2, 3) on a preform rod (1), over its entire length, wherein the two or more pairs of grooves (2, 3) are mirror-symmetrical relative to at least one plane passing through a longitudinal rotation axis of the preform rod (1) and wherein within each pair of grooves (2, 3) the shape and size of the grooves are similar;
inserting the preform rod (1) into a tube (4) of optical material, the tube (4) having an inner surface with a diameter not smaller than an external diameter of the preform rod (1);
fusing the preform rod (1) and the tube (4) in a nonworking area (6);
pulling the fused preform rod (1) and tube (4) into a preform (5), the preform (5) having longitudinal channels (8) resulting from the mirror-symmetrical grooves (2, 3) and the inner surface of the tube (4);
cutting the preform (5) into at least one preform segment;
performing the following steps for at least one preform segment:
etching the longitudinal channels (8) of the preform segment to form etched channels (9);
sealing both ends (12) of the preform segment;
making an assembly of the preform segment and a capillary tube (13) carrying a tubular process holder (14);
joining the preform segment and the capillary tube (13) on a side (15) opposite to the tubular process holder (14);
drawing the assembly of the preform segment and the capillary tube into an optical fiber, and
applying a protective strengthening coating (17) on the drawn optical fiber;
whereby an optical fiber is produced, the optical fiber having birefringent properties influenced by dimensions of the mirror-symmetrical grooves and the etching step.

2. The method according to claim 1, further comprising rotating the preform segment during the step of drawing the preform segment into the optical fiber.

3. The method according to claim 1, further comprising sealing both ends (12) of the preform segment.

4. The method according to claim 3, further comprising filling the preform with pressurized gas before sealing.

5. The method according to claim 1, wherein HF acid is used in said etching.

6. The method according to claim 1, further comprising washing and drying internal and external surfaces of the preform segment.

7. The method according to claim 1, wherein the number of pairs of grooves is at least two.

8. The method according to claim 1, wherein the number of pairs of grooves is at least three.

9. The method according to claim 1, wherein the grooves inscribe an ellipse, the ellipticity of which is at least 0.05.
